(19) United States
(12) Patent Application Publication
(10) Pub. No.: US 2026/0084325 A1
(43) Pub. Date: Mar. 26, 2026

(54) COMPLIANT COVERINGS FOR A ROBOTIC HAND

(71) Applicant: Sanctuary Cognitive Systems Corporation, Vancouver (CA)

(72) Inventors: Connor Richard Shannon, Vancouver (CA); Jeremy A. Fishel, Chico, CA (US); Ethan A. Lodermeier, Vancouver (CA)

(21) Appl. No.: 19/336,930

(22) Filed: Sep. 23, 2025

Related U.S. Application Data
(60) Provisional application No. 63/698,678, filed on Sep. 25, 2024.

(51) Int. Cl. B25J 19/00; B25J 15/00; B32B 5/02; B32B 25/10; B32B 25/20

(52) U.S. Cl. CPC B25J 19/0075; B32B 5/026; B32B 25/10; B32B 25/20; B25J 15/0009; B32B 2307/584; B32B 2307/7376

(57) ABSTRACT

A compliant covering for a hand includes a sheath having an interior space to receive at least a part of the hand. The sheath includes an inner sheath layer having an inner surface defining a boundary of the interior space. The inner layer is formed of a first material. The sheath includes an outer sheath layer at least partially covering an exterior of the inner sheath layer. The outer sheath layer has an outer surface forming an exterior of the sheath. The outer sheath layer is formed of a second material having a higher abrasion resistance compared to the first material.

### CROSS-REFERENCE TO RELATED APPLICATIONS

This application claims the benefit of U.S. Provisional Application No. 63/698,678 filed Sep. 25, 2024, the disclosure of which is incorporated herein by reference.

### FIELD

The field relates generally to hand coverings and to protection of robotic hands with haptic sensors.

### BACKGROUND

Robots are machines that can sense their environments and perform tasks autonomously or semi-autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans.

### SUMMARY

Described herein are compliant coverings that can be worn on the robotic hand to cover surfaces of the robotic hand, which can include sensing regions with sensors. The compliant coverings can prevent direct contact between sensors on the robotic hand and surfaces and objects in the external environment of the robotic hand, thereby protecting the sensors from damage (e.g., wear, abrasion, puncture, or tear), while allowing the sensors to detect stimuli from the external environment.

In a representative example, a compliant covering for a hand includes a sheath having an interior space to receive at least a part of the hand. The sheath includes an inner sheath layer having an inner surface defining a boundary of the interior space. The inner sheath layer is formed of a first material. The sheath includes an outer sheath layer at least partially covering an exterior of the inner sheath layer. The outer sheath layer has an outer surface forming an exterior of the sheath. The outer sheath layer is formed of a second material having a higher abrasion resistance compared to the first material.

In a representative example, a method of making a compliant covering for a hand includes obtaining a mold core including a hand-shaped part. The method includes forming an outer sheath of the compliant covering from a fabric. The outer sheath has an interior space shaped to receive the hand-shaped part with an allowance. The method includes mounting the outer sheath in a backing mold to form a mold cavity including the interior space. The method includes inserting the hand-shaped part of the mold core into the interior space in the mold cavity to form a hand-shaped channel between the hand-shaped part and the outer sheath. The method includes pouring a soft elastomer in a molten state into the mold cavity. The soft elastomer flows into the hand-shaped channel and permeates the outer sheath. The method includes curing the soft elastomer in the mold cavity. The cured soft elastomer in the hand-shaped channel forms an inner sheath of the compliant covering and is interlocked with the outer sheath. The sheath is separated from the mold cavity and mold core.

### BRIEF DESCRIPTION OF THE DRAWINGS

FIG. 1 is a front view of a compliant covering in the form of a glove for a hand.

FIG. 2 is a back view of the compliant covering of FIG. 1.

FIG. 3 is a cross-sectional view of the compliant covering of FIG. 1 along line 3-3 as shown in FIG. 4.

FIG. 4 is a cross-sectional view of the compliant covering of FIG. 1 along line 4-4 as shown in FIG. 3.

FIG. 5A is a cross-sectional view of the compliant covering of FIG. 1 along line 5A-5A as shown in FIG. 4 and a ventral view of a robotic hand inserted in an interior space of the compliant covering.

FIG. 5B is a cross-sectional view of the compliant covering of FIG. 1 along line 5B-5B as shown in FIG. 4 and a dorsal view of a robotic hand inserted in an interior space of the compliant covering.

FIG. 6 is a cross-sectional view of the compliant covering as shown in FIG. 4 and a cross-sectional view of a robotic hand, along line 6-6 as shown in FIG. 5A, inserted in an interior space of the compliant covering.

FIG. 7A illustrates slits formed in a back side of the compliant glove.

FIG. 7B illustrates another arrangement of slits formed in the back side of the compliant glove.

FIG. 8 illustrates fastener holes at the edges of the slits shown in FIG. 7A.

FIG. 9 illustrates lacing of one of the slits shown in FIG. 7A.

FIG. 10 illustrates zippers installed in the slits shown in FIG. 7A.

FIG. 11 illustrates a strap extending across the slits shown in FIG. 7A.

FIG. 12A is a front view of a compliant finger cot for a robotic finger.

FIG. 12B is a front view of a compliant thumb cot for a robotic thumb.

FIG. 12C is a front view of a compliant fingerless glove for a robotic hand.

FIG. 13A is a cross-sectional view of a sheath structure for a compliant covering.

FIG. 13B is a cross-sectional view of the sheath structure as shown in FIG. 13A with soft compliant portions from an inner sheath layer of the sheath structure protruding into an outer sheath layer of the sheath structure.

FIG. 13C is a cross-sectional view of the sheath structure as shown in FIG. 13B with an interlock profile on an inner surface of the inner sheath layer.

FIG. 13D is a cross-sectional view of the sheath structure as shown in FIG. 13B with another interlock profile on an inner surface of the inner sheath layer.

FIG. 13E is a cross-sectional view of the sheath structure as shown in FIG. 13B with a depression formed in an inner surface of the inner sheath layer.

FIG. 13F is a cross-sectional view of a sheath structure as shown in FIG. 13B with the soft compliant portions from the inner sheath layer exposed at an outer surface of the outer sheath layer.

FIG. 13G is a cross-sectional view of a sheath structure as shown in FIG. 13F with soft compliant portions from the inner sheath layer protruding into an innermost layer of the outer sheath layer and the innermost layer covered by an outermost layer of the outer sheath layer.

FIG. 14A is a cross-sectional view of another sheath structure.

FIG. 14B is a cross-sectional view of the sheath structure as shown in FIG. 14A with a depression formed in an inner surface of the inner sheath layer of the sheath structure.

FIG. 14C is a cross-sectional view of the sheath structure as shown in FIG. 14B with an interlock profile formed on a surface of the depression.

FIG. 15 is a method of making a compliant covering with the sheath structure shown in FIGS. 13A-13B and 13F.

FIG. 16A is a perspective view of a mold core.

FIG. 16B is a perspective view of an outer sheath.

FIG. 16C is a cross-sectional view of an assembly including the outer sheath of FIG. 16B supported in a backing mold.

FIG. 16D is a cross-sectional view of the assembly as shown in FIG. 16C with the mold core of FIG. 16A suspended in an interior space of the outer sheath.

FIG. 16E is a cross-sectional view of the assembly as shown in FIG. 16D with arrows depicting movement of molten material within the assembly.

FIG. 16F is a cross-sectional view of the assembly of FIG. 16E with an inner sheath formed between the mold core and the outer sheath.

FIG. 16G is a cross-sectional view of an alternative assembly for making a compliant covering using a combination of the sheath structures shown in FIGS. 13A-13B and 14A.

### DETAILED DESCRIPTION

### General Considerations

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or linked and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Sensing regions on a robotic hand can include sensors (e.g., tactile sensors) with delicate parts (e.g., soft compliant parts) that are susceptible to damage (e.g., wear abrasion, puncture, or tear) from direct contact with surfaces and objects in an external environment of the robotic hand (e.g., surfaces and objects that can be encountered while the robotic hand is performing dexterous manipulation).

Described herein are compliant coverings that can be worn on the robotic hand to cover surfaces of the robotic hand, which can include sensing regions with sensors. The compliant coverings can prevent direct contact between sensors on the robotic hand and surfaces and objects in the external environment of the robotic hand, which can have the effect of elongating the lifetime of the sensors compared to if the sensors were in direct contact with surfaces and objects in the external environment.

The compliant coverings can deform to transmit stimuli (e.g., touch stimuli) from the external environment of the robotic hand to the sensors on the robotic hand, which means that the compliant coverings can protect the sensors from damage without preventing the sensors from responding to stimuli from the external environment.

In some aspects, sensors can be integrated in the compliant coverings so that sensing regions can be formed on the robotic hand by wearing the compliant coverings with the integrated sensors.

### Example II—Compliant Coverings

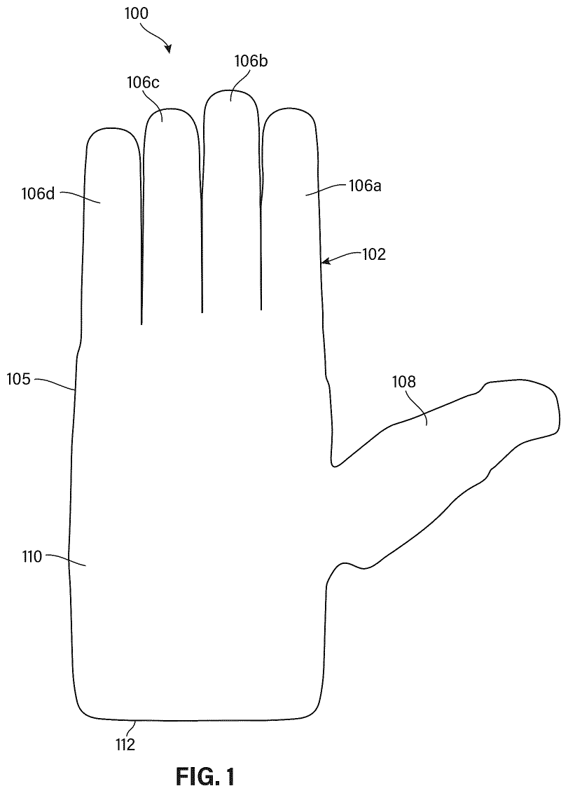

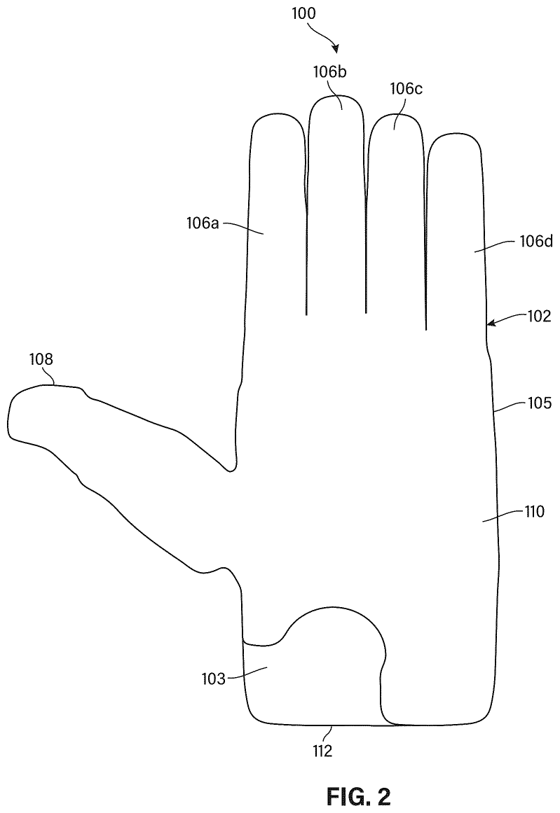

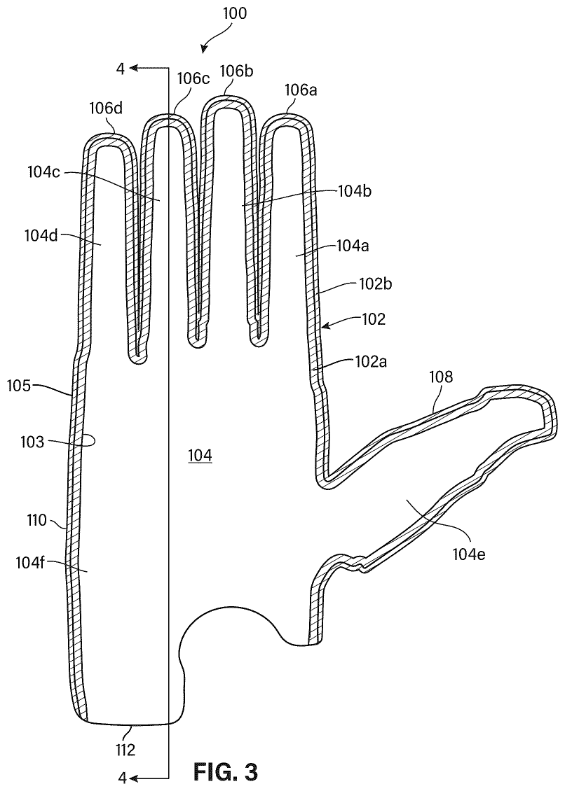

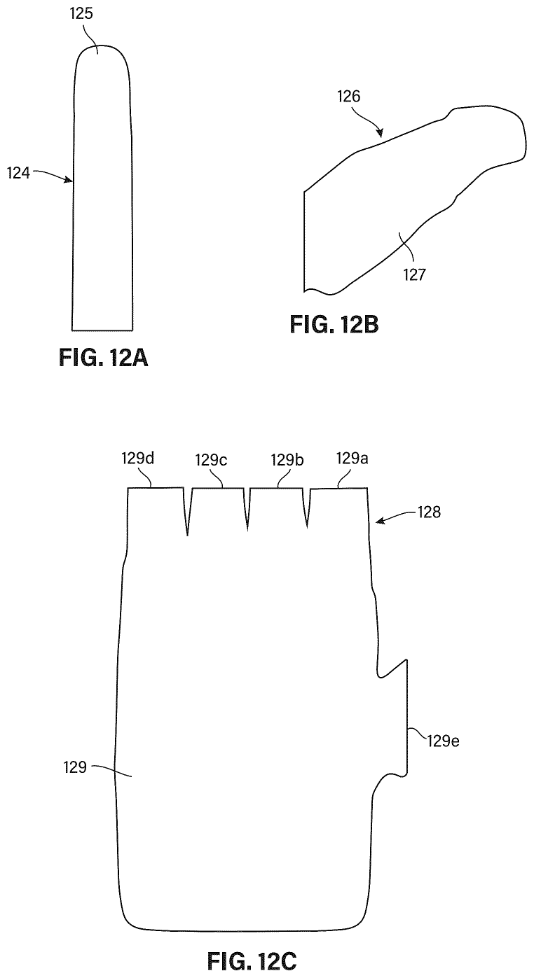

FIGS. 1-4 illustrate an example compliant covering 100 including a sheath 102 having an interior space 104 (shown in FIG. 3) to receive a hand and an outer surface 105 that is exposed to an external environment and therefore can directly contact surfaces and objects in the external environment. In the illustrated example, the compliant covering 100 (or sheath 102) is in the form of a glove for a hand. In other examples, the compliant covering 100 may have other forms that partially cover the hand (see FIGS. 12A-12C).

The sheath 102 can include finger sheath parts 106a-d, a thumb sheath part 108, and a palm sheath part 110. The sheath 102 has an inner surface 103 (shown in FIG. 3) defining the interior space 104 to receive a hand. Each of the sheath parts 106a-d, 108, 110 includes a corresponding portion 104a-f of the interior space 104 to receive a corresponding portion of the hand. The sheath 102 includes an end opening 112 through which a hand may be inserted into the interior space 104 or through which a hand may extend out of the sheath 102 when inserted into the interior space 104.

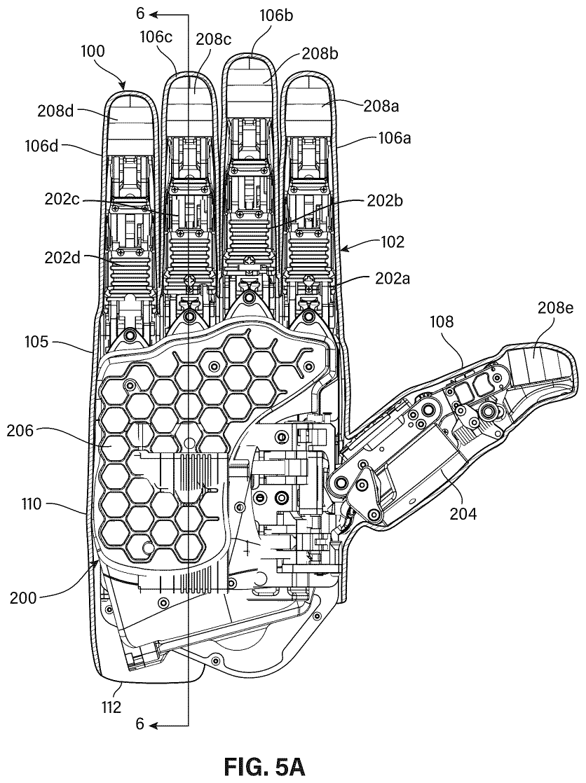

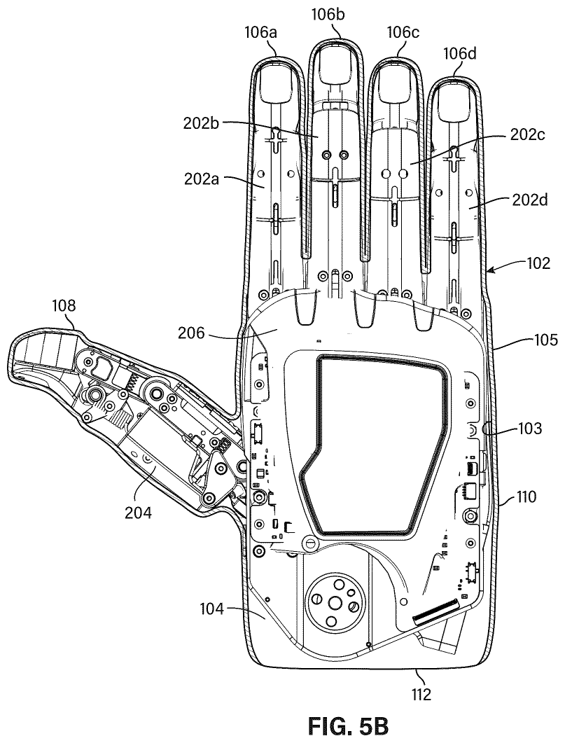

In the illustrated examples, the sheath 102 has four finger sheath parts 106a-d to receive four fingers of a hand. In other examples, the sheath 102 may have fewer than or more than four finger sheath parts depending on the design of the hand to be covered by the compliant covering 100. In the example, the sheath 102 has one thumb sheath part 108 to receive a thumb of a hand (e.g., thumb 204 of the robotic hand 200 as shown in FIGS. 5A and 5B). In other examples, the sheath 102 may have more than one thumb sheath part or no thumb sheath part depending on the design of the hand to be covered by the compliant covering 100.

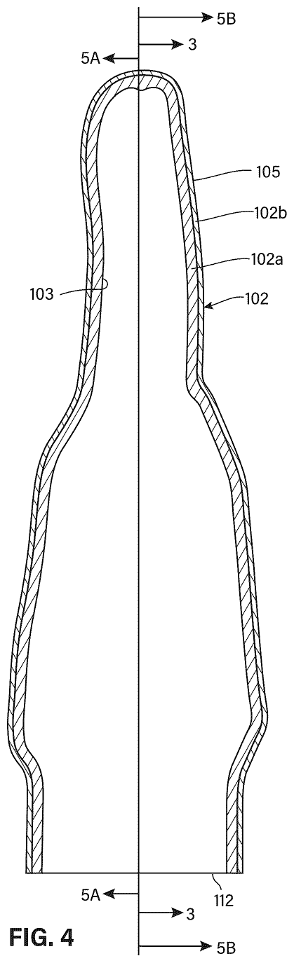

The sheath 102 may be a laminate sheath composed of two or more sheath layers. In some examples, as illustrated in FIGS. 3-4, the sheath 102 includes an inner sheath layer 102a and an outer sheath layer 102b. The inner sheath layer 102a includes the inner surface 103 that defines the interior space 104. The outer sheath layer 102a covers an exterior of the inner sheath layer 102b and includes the outer surface 105 of the sheath 102 that defines the exterior of the sheath 102. Each of the sheath layers 102a, 102b may be monolayer or multilayer.

The inner sheath layer 102a is formed of a soft compliant material, and the outer sheath layer 102b is formed of an abrasion-resistant material having a higher abrasion resistance compared to the soft compliant material. The soft compliant material allows the inner sheath layer 102b to be deformable to transmit an applied stimuli from an external environment to a portion of the hand disposed within the interior space 104. The abrasion-resistant material allows the outer sheath layer 102b to protect the inner sheath layer 102a from damage due to friction from contact with surfaces and objects in the external environment, which ultimately protects the hand disposed within the interior space 104 from damage. The laminate structure of the sheath 102 is further described in Examples III and IV.

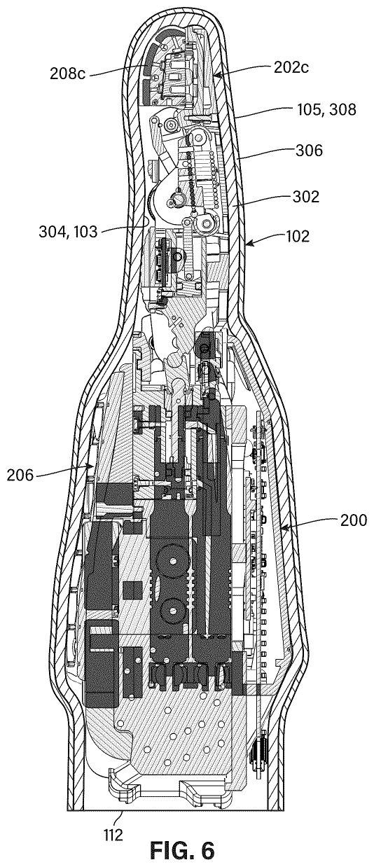

FIGS. 5A, 5B, and 6 show a robotic hand 200 received in the interior space 104 of the sheath 102. The robotic hand 200 includes an index finger 202a disposed in the finger sheath part 106a, a middle finger 202b disposed in the finger sheath part 106b, a ring finger 202c disposed in the finger sheath part 106c, a little finger 202d disposed in the finger sheath part 106d, a thumb 204 disposed in the thumb sheath part 108, and a palm 206 disposed in the palm sheath part 110.

The robotic hand 200 may have one or more sensing regions including one or more sensors. In the example, tactile sensors 208a-d are coupled to the fingers 202a-202d and disposed in the respective finger sheath parts 106a-d. A tactile sensor 208e may be coupled to the thumb 204 and disposed in the respective thumb sheath part 108. The tactile sensors 208a-e define sensing regions on the fingers 202a-202d and thumb 204. Although not shown, sensors may also be attached to the palm 206 of the robotic hand 200 to define one or more sensing regions on the palm 206. The sensors on the palm 206 may be disposed in and covered by the palm sheath part 108.

In some examples, sensors can be attached to or embedded in the inner sheath layer 102a of the sheath 102 to provide the sheath 102, the robotic hand 200 is provided with sensing regions from the sensors on the sheath 102. In some examples, a combination of sensors directly attached to the robotic hand 200 and sensors integrated into the inner sheath layer 102a of the sheath may be used to provide the robotic hand 200 with sensing regions. For example, a first set of sensors may be directly attached to the fingers and thumb of the robotic hand 200 and a second set of sensors may be integrated into the palm sheath 110 of the sheath 102.

In some examples, the sheath 102 can be sized to be form-fitting on the robotic hand so that the sheath 102 can essentially function as a skin for the robotic hand. To prevent damage to sensors on the robotic hand (or sensors integrated into the sheath 102) when inserting the robotic hand into the interior space 104 of the sheath 102, the sheath 102 may include structural elements that allow the sheath 102 to be fitted onto the robotic hand without dragging the sheath 102 across surfaces of the robotic hand. In some examples, the structural elements can be slits formed in the sheath parts or expandible structures (e.g., stretchable material or accordion-like material) formed in the sheath parts. Closure elements may be used to secure the sheath 102 in place after the robotic hand is fitted into the interior space 104 of the sheath 102.

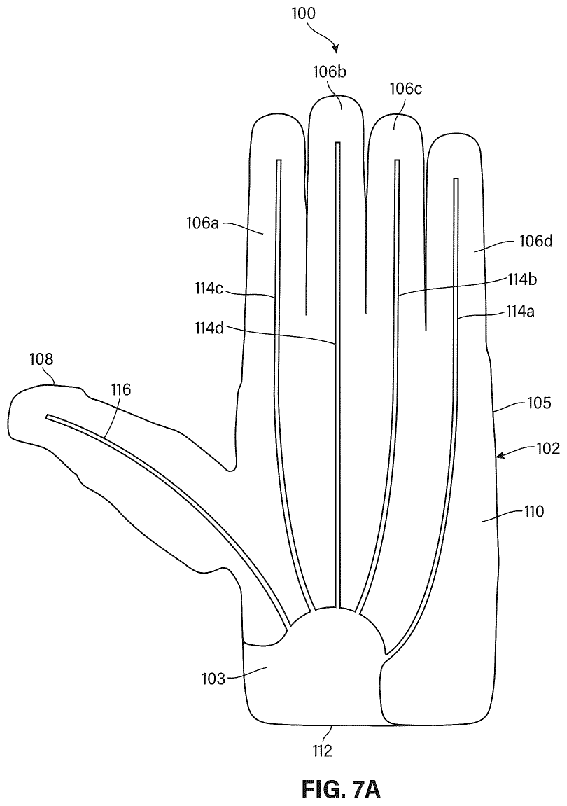

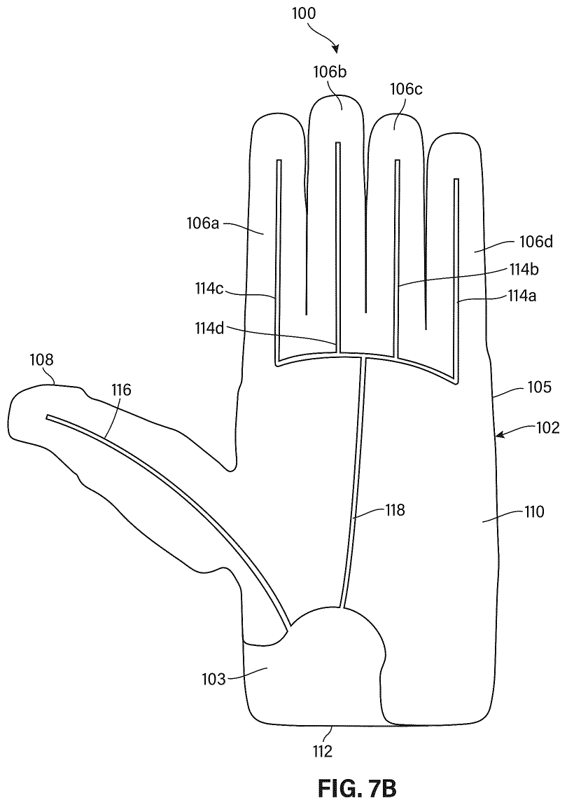

FIG. 7A illustrates slits 114a-d formed in the dorsal sides of the finger sheath parts 106a-d and a slit 116 formed in the dorsal side of the thumb sheath part 108. The slits 114a-d, 116 extend to the end opening 112 of the sheath 102. Each of the slits 114a-d, 116 represents a location at which the sheath 102 can be parted to facilitate fitting of the sheath 102 on the hand. In a variant example, as shown in FIG. 7B, the slits 114a-d may terminate at the bases of the finger sheath parts 106a-d. The palm sheath part 110 may be split from the bases of the finger sheath parts 106a-d at the dorsal side of the sheath 102 and may include a mid-slit 118. The slit 116 in the dorsal side of the thumb sheath part 108 may extend to the palm sheath part 110 as in the example shown in FIG. 7A. Other slit arrangements that can facilitate fitting of the sheath 102 on the hand are plausible.

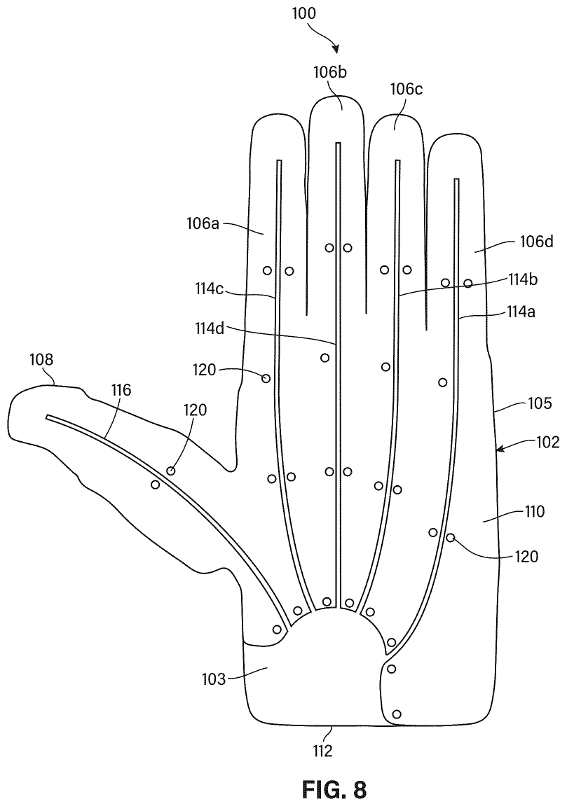

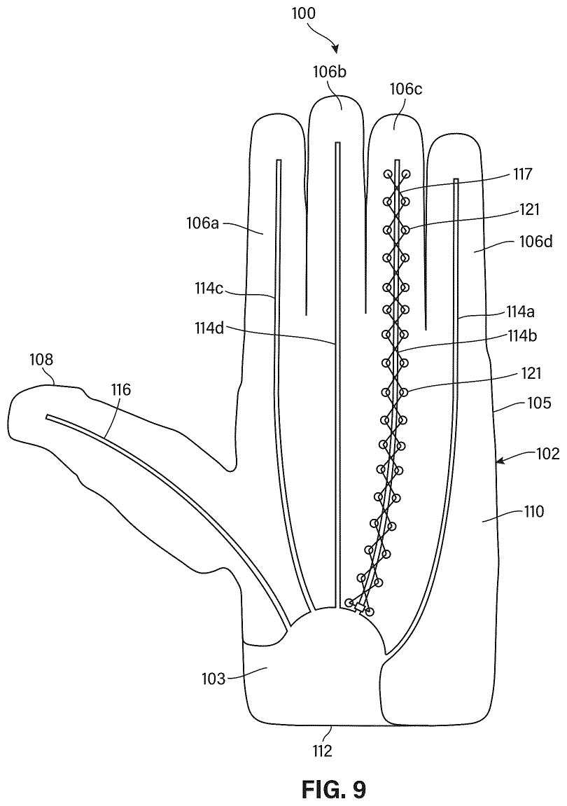

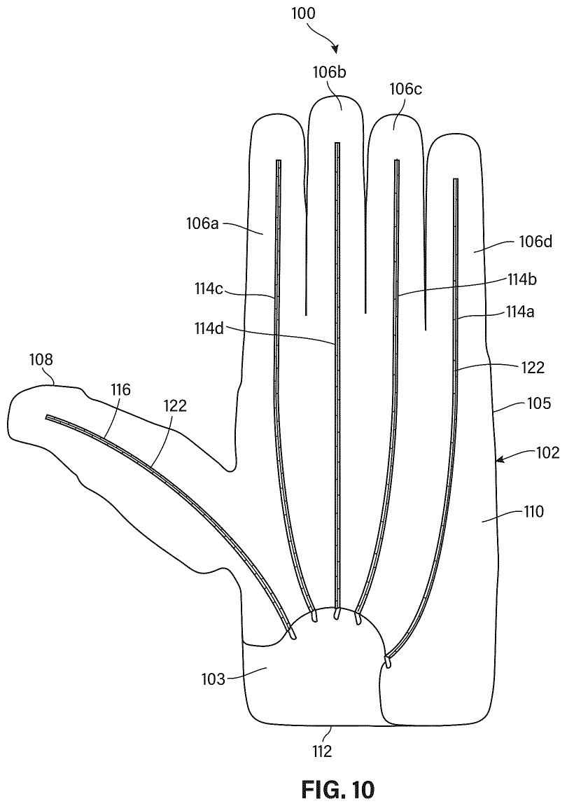

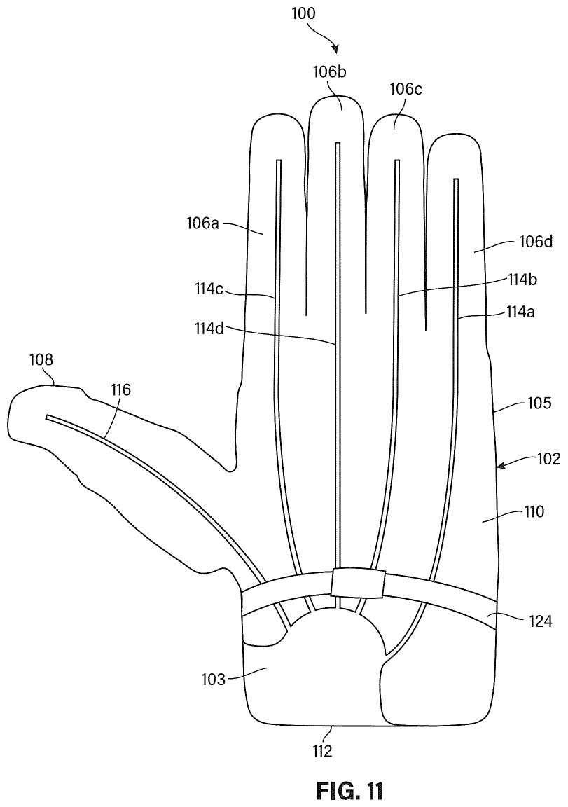

FIG. 8 illustrates fastener holes 120 formed in edge portions of the slits 114a-d, 116. The sheath 102 may be secured in place by extending fasteners (e.g., screws) through the fastener holes 120 and into the hand. In a variation of the example shown in FIG. 8, eyelets may be formed along the edge portions of the slits 114a-d, 116 for lacing of the edge portions. FIG. 9 illustrates eyelets 121 formed along opposite edge portions of the slit 114b. A lace 117 can be threaded through the eyelets 121 and across the slit 114b to secure the sheath 102 at the slit 114b. In another example, as shown in FIG. 10, zippers 122 may be installed in the slits 114a-d, 116 and used to secure the sheath 102 at the slits 114a-d, 116. In other examples, a strap or tab that extends over individual slits or a group of slits in the sheath 102 (see, e.g., strap 124 in FIG. 11 that extends over slits 114a-d, 116 and that is secured using a suitable closure such as a buckle or Velcro closure or snap closure) may be used to secure the sheath 102 at the slits. Any combination of these closure elements may be used in the compliant covering.

In some examples, compliant coverings that partially cover the hand may be constructed using fewer than all the parts of the sheath 102. For example, FIG. 12A shows a compliant covering 124 in the form of a finger cot. The compliant covering 124 includes a finger sheath 125 that can receive a single finger of a hand. FIG. 12B shows a compliant covering 126 in the form of a thumb cot. The compliant covering 126 includes a thumb sheath 127 that can receive a thumb of a hand. FIG. 12C shows a compliant covering 128 in the form of a fingerless glove (or a palm covering). The compliant covering 128 includes a palm sheath 129 with openings 129a-e for fingers and a thumb of a hand. Any combination of these partial hand coverings may be used to cover a hand. Any of these partial hand coverings may have integrated sensors.

### Example III—Sheath Structure

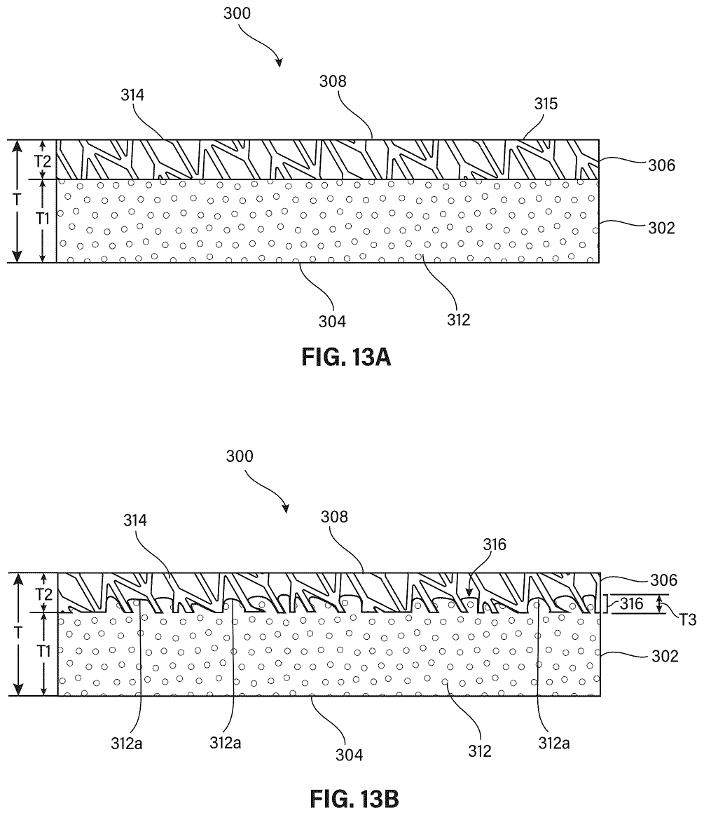

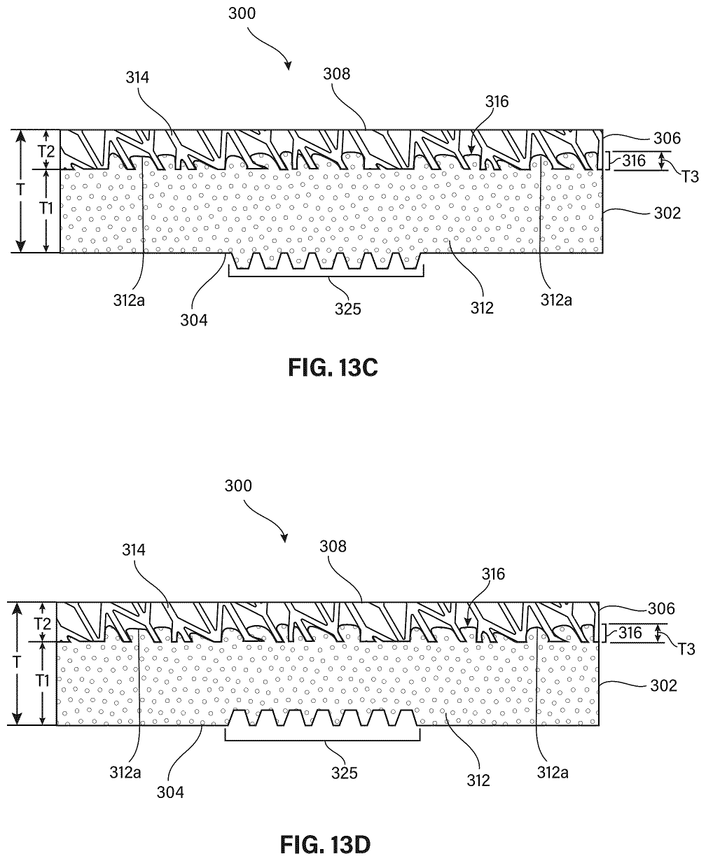

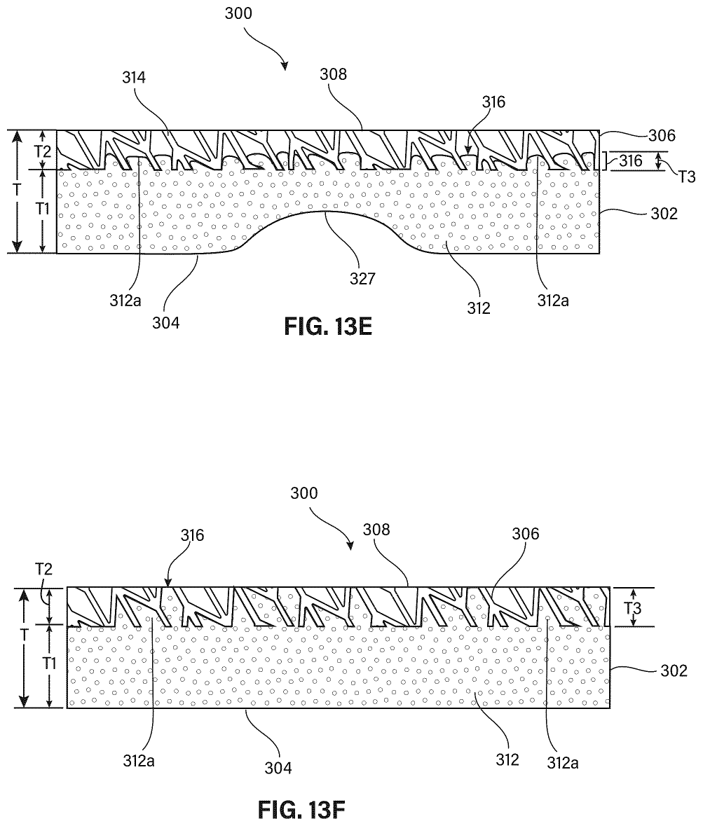

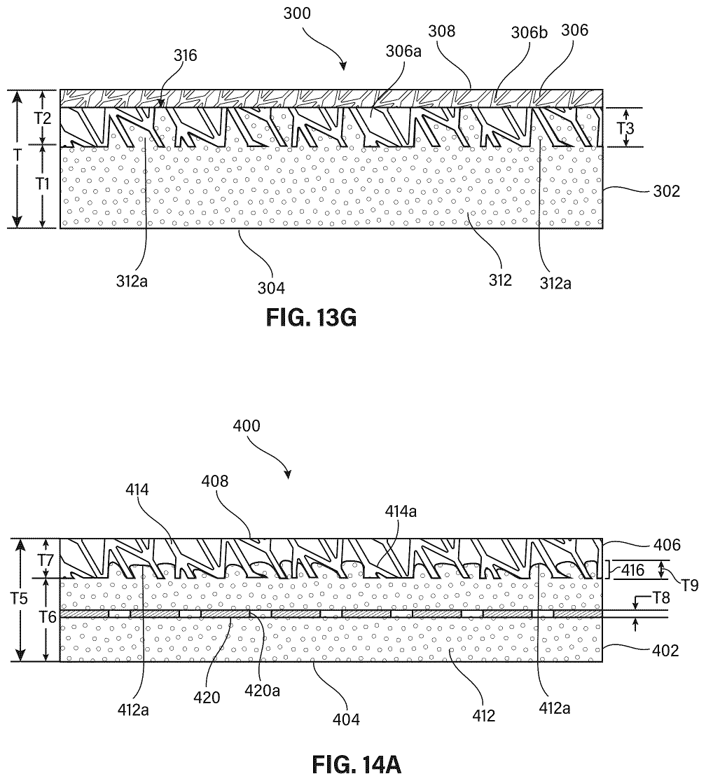

FIG. 13A illustrates an example sheath structure 300 that may be used in the parts of the sheath 102 (see FIGS. 1-11 and Example II) or in only a few of the parts of the sheath 102 (e.g., the finger sheath parts 106a-d and thumb part 108 may have the sheath structure 300, while the palm sheath part 110 may have a different sheath structure (e.g., the sheath structure 500 in Example IV)).

The sheath structure 300 includes an inner sheath layer 302 (corresponding to the inner sheath layer 102a in FIGS. 3-4) having an inner surface 304 (corresponding to the inner surface 103 of the sheath 102 in FIGS. 3-4) and an outer sheath layer 306 (corresponding to the outer sheath 102b in FIGS. 3-4) having an outer surface 308 (corresponding to the outer surface 105 of the sheath 102 in FIGS. 3-4). The inner and outer surfaces 304, 308 are disposed on opposite sides of the sheath structure 300. The inner surface 304 is the side of the sheath structure 103 that is exposed to the interior space 104 (see FIGS. 3-4) of the sheath 102. The outer surface 308 is the side of the sheath structure 300 that is exposed to the external environment. Each of the inner sheath layer 302 and outer sheath layer 306 may be monolayer or multilayer (FIG. 13G shows an example of an outer sheath layer 306 having two layers).

The inner sheath layer 302 is formed of a soft compliant material 312. In some examples, the soft compliant material 312 can be a soft elastomer (e.g., silicone elastomer). The outer sheath layer 306 is formed of an abrasion-resistant material 314. An abrasion resistant material is a material that can resist wear from rubbing against it. The soft compliant material 312 can be a material having a relatively low abrasion resistance. The abrasion-resistant material 314 can be a material having a relatively high abrasion resistance.

In some examples, the abrasion-resistant material 314 can be a fabric having a 3D structure (e.g., a 3D knitted fabric or 3D woven fabric or a 3D non-woven fabric). The fabric can be made using synthetic or natural fiber. The fabric may have characteristics tailored to the use environment of the sheath 102. For example, the fabric may be flame-resistant or chemical-resistant or have other desirable properties.

In other examples, the abrasion-resistant material 314 may be an abrasion-resistant elastomer, such as a high abrasion rubber (e.g., nitrile, neoprene, or Viton rubber).

The inner sheath layer 302 is coupled to the outer sheath layer 306 in a manner that avoids relative slippage between the inner sheath layer 302 and the outer sheath layer 306 when the sheath 102 is worn on the hand or otherwise in use. For example, the inner sheath layer 302 may be bonded or otherwise fused to the outer sheath layer 306 at the interface 315 to form a laminate structure.

In some examples, as illustrated in FIG. 13B, the inner sheath layer 302 may be adjoined to the outer sheath layer 306 via an interlocking interface 316 including portions 312a of the soft compliant material 312 protruding into open spaces in the abrasion-resistant material 314. The soft compliant material portions 312a may be fused or bonded to the outer sheath layer 306 at the interlocking interface 316.

In some examples, as shown in FIGS. 13C and 13D, a portion of the inner surface 304 to be used in a sensing region of the hand may include an interlock profile 325 that is adapted to engage a complementary interlocking profile in the sensing region of the hand. For example, an outer part of a sensor on the hand may have an interlock profile that is complementary to the interlock profile 325. When the sheath 102 is fitted on the hand, the interlock profile 325 can be in a location to engage the interlock profile of the sensor on the hand. The resulting interlocked engagement formed between the inner surface 304 and the sensor can prevent slippage between the sheath 102 and the sensor. The interlock profile 325 may be, for example, a sawtooth profile, ridged profile, or other similar profile that can be used to form an interlocking interface between two opposing surfaces.

In some examples, as shown in FIG. 13E, a portion of the inner surface 304 to be used in a sensing region of the hand may include a depression 327 (or cavity) shaped to receive an outer part of a sensor in a sensing region of a hand. The depression 327 can be at a location that would correspond to the location of the sensor on the hand when the sheath 102 is fitted over the hand. In some examples, the surface of the depression 327 may include an interlock profile (such as interlock profile 325 shown in FIGS. 13C and 13D) that allows the surface of the depression 327 to interlock with the sensor part received in the depression 327. This interlocking engagement can act to prevent slippage between the sheath 102 and the sensor.

In some examples, a sensor may be integrated into the sheath structure 300 by installing the sensor in the depression 327. The sensor may be attached to the surface of the depression 327 using any suitable method (e.g., bonding). In some examples, the sensor and depression 327 may have interlocking profiles that can engage each other to discourage delamination of the sensor from the surface of the depression.

In the examples illustrated in FIGS. 13B-13E, the soft compliant material portions 312a are shown extending partway into the outer sheath layer 306. In other examples, as illustrated in FIG. 13F, the soft compliant material portions 312a can protrude into open spaces in the abrasion-resistant material 314 and extend to the outer surface 308 of the outer sheath layer 306 such that the soft compliant material portions 312a are exposed at the outer surface 308.

In another example, as illustrated in FIG. 13G, the outer sheath layer 306 can include an innermost outer sheath layer 306a adjacent to the inner sheath layer 302 and an outermost outer sheath layer 306b adjacent to the innermost outer sheath layer 306a. The outermost outer sheath layer 306b includes or defines the outer surface 308 of the outer sheath layer 306. The soft compliant material portions 312a can protrude into open spaces in the abrasion-resistant material 314a of the innermost outer sheath layer 306a. In this example, the innermost outer sheath layer 306a is covered by the outermost outer sheath layer 306b so that the soft compliant material portions 312a are not exposed at the outer surface 308 of the outer sheath layer 306.

The thickness T of the sheath structure 300 may be selected to achieve a desired sensitivity and durability of the sheath 102. In general, the durability of the sheath 102 increases with increasing thickness T, while the sensitivity of the sheath 102 (e.g., ease of deforming the sheath structure 300 to transmit stimuli) increases with decreasing thickness T. In some examples, the thickness T of the sheath structure 300 may be selected based solely on sensitivity considerations or based on a compromise between sensitivity and durability.

In other examples, the thickness T of the sheath structure 300 may be non-uniform across the sheath 102. For example, the thickness of the sheath structure 300 in a portion of the sheath 102 that would cover a sensing region of the hand may be different from the thickness of the sheath structure 300 in another portion of the sheath 102 that would not cover a sensing region of the hand or in another portion of the sheath 102 that would cover a different type of sensing region (e.g., a sensing region on a finger versus a sensor region on a palm). Non-uniformity of the thickness of the sheath structure 300 across the sheath 102 can allow tuning of the sensitivity of the sheath 102 for different sensing regions of the hand.

In some examples, the thickness T of the sheath structure 300 may be comparable to the thickness of human skin. In some examples, the inner sheath layer 302 can have a thickness T1 in a range from 3 mm to 6 mm, and the outer sheath layer 306 can have a thickness T2 in a range from 0.2 mm to 1 mm. In some examples, the interlocking interface 316 (shown in FIG. 13B) between the inner sheath layer 302 and the outer sheath layer 306, if present in the sheath structure 300, can have a thickness T3 in a range from 0.2 mm to 1 mm. In some examples, thickness T3 can be less than thickness T2. In other examples, thickness T3 can be the same as thickness T2 (e.g., when the soft compliant portions 312a are exposed at the outer surface 308 as shown in FIG. 13F). The thickness T of the sheath structure 300, which is the sum of the thicknesses T1 and T2, can be in a range from 3 mm to 7 mm. In cases where the thickness T of the sheath structure 300 varies across the sheath 102, the thickness T2 of the outer sheath layer 306 may be held relatively uniform while the thickness T1 of the inner sheath layer 302 is varied.

### Example IV—Sheath Structure with Reinforcement

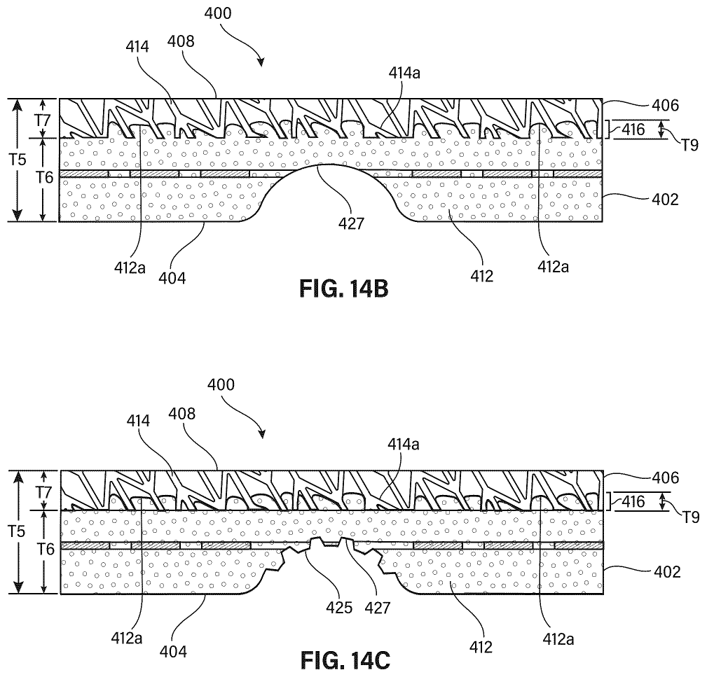

FIGS. 14A-14B illustrate an example sheath structure 400 for the sheath 102 (see FIGS. 1-11 and Example II). The sheath structure 400 is structurally similar to the sheath structure 300 in Example III with the exception of use of a reinforcement member in the inner sheath layer to increase the overall strength of the sheath structure. The sheath structure 400 may be used in parts of the sheath 102 where higher strength is desired (e.g., in the palm sheath part of the sheath 102).

The sheath structure 400 includes an inner sheath layer 402 (corresponding to the inner sheath layer 102a in FIGS. 3-4) having an inner surface 404 (corresponding to the inner surface 103 of the sheath 102 in FIGS. 3-4) and an outer sheath layer 406 (corresponding to the outer sheath layer 102b in FIGS. 3-4) having an outer surface 408 (corresponding to the outer surface 102 of the sheath 102 in FIGS. 3-4). The inner and outer surfaces 404, 408 are disposed on opposite sides of the sheath structure 400. The inner surface 404 forms the interior side of the sheath structure 400 (e.g., the surface that is exposed to the interior space 104 of the sheath 102), and the outer surface 408 forms the exterior side of the sheath structure 400 (e.g., the surface that is exposed to the external environment). Each of the inner sheath layer 402 and outer sheath layer 406 may be single-layered or multilayered.

The inner sheath layer 402 is formed of a soft compliant material 412. The outer sheath layer 406 is formed of an abrasion-resistant material 414. The soft compliant material 412 can be a material having a relatively low abrasion resistance. The abrasion-resistant material 414 can be a material having a relatively high abrasion resistance. The soft compliant material 412 can have any of the properties described for the soft compliant material 312 in Example III. The abrasion-resistant material 414 can have any of the properties described for the abrasion-resistant material 314 in Example III.

The inner sheath layer 402 is coupled to the outer sheath 406 in a manner that avoids relative slippage between the inner sheath layer 402 and the outer sheath layer 406. In some examples, the inner sheath layer 402 may be attached directly to the outer sheath layer 406 (e.g., by fusing or bonding). In other examples, there may be an intermediary layer between the inner sheath layer 402 and the outer sheath layer 406 that couples the inner sheath layer 402 to the outer sheath layer 406.

In the illustrated example, the inner sheath layer 402 is coupled to the outer sheath layer 404 by an interlocking interface 416 including portions 412a of the soft compliant material portions 412 protruding into open spaces in an adjacent portion 414a of the abrasion-resistant material 414. The soft compliant material portions 412a may be bonded or fused to the abrasion-resistant material portion 414a to form an interlocking seam between the inner sheath layer 402 and the outer sheath layer 406.

In some examples, the soft compliant material portions 412a can extend all the way to the outer surface 408 of the outer sheath layer 406 (e.g., as illustrated for soft compliant material portions 312a in FIG. 13F). In some examples, the outer sheath layer 406 may have multiple layers with at least one layer preventing exposure of the soft compliant material portions 412a at the outer surface 408 of the outer sheath layer 406 (e.g., as illustrated for the outer sheath layer 306 and soft compliant material portions 312a in FIG. 13G).

The sheath structure 400 includes a reinforcement member 420 embedded in the inner sheath layer 402. The reinforcement member 420 is a member that is relatively thin compared to the inner sheath layer 402 and formed of a material having a higher strength compared to the soft compliant material 412. The reinforcement member 420 may be formed of a material such as plastic or metal. The reinforcement member 420 can allow the sheath structure 400 to have a higher strength compared to the sheath structure 300 described in Example III.

The reinforcement member 420 may be, for example, a perforated sheet or mesh or other similar structure with open spaces (or pores). In the illustrated example, the soft compliant material 412 of the inner sheath layer 502 extends through open spaces 420a (or pores) in the reinforcement member 420 and forms continuous soft compliant material portions on either side of the reinforcement member 420 so that the reinforcement member 420 and the soft compliant material 412 are interlocked.

In some examples, as shown in FIG. 14B, the inner surface 404 may include one or more depressions (e.g., depression 427) shaped to receive a sensor attached to a sensing region of a hand. In some examples, as shown in FIG. 14C, the surface of the depression 427 may include an interlock profile 425 that allows an interlocking interface to be formed between surface of the depression 427 and the sensor part received in the depression 427. The interlocking interface can act to prevent slippage between the inner surface 404 of the sheath structure 400 and the sensor.

In some examples, a sensor may be integrated into the sheath structure 400 by installing the sensor in the depression 427. The sensor may be attached to the surface of the depression 427 using any suitable method (e.g., bonding). In some examples, the sensor may include an interlock profile that can engage the interlock profile 425 of the depression 427 in order to discourage delamination of the sensor from the surface of the depression 427.

The thickness T5 of the sheath structure 400 may be selected to achieve a desired sensitivity and durability of the sheath 102 as described for the sheath structure 300 in Example III. The thickness T8 of the reinforcement member 420 may be selected to achieve a desired increased strength of the sheath structure 400. The thickness T6 of the inner sheath layer 402 may be selected based on a desired sensitivity and based on accommodating the reinforcement member 420. The thickness T7 of the outer sheath layer 406 may be selected based on sheath durability considerations.

In some examples, the thickness T6 of the inner sheath layer 402 can be in a range from 3 mm to 10 mm; the thickness T7 of the outer sheath layer 406 can be in a range from 0.2 mm to 1 mm; the thickness T8 of the reinforcement member can be in a range from 0.1 mm to 0.3 mm; and the thickness T9 of the interlocking interface 416, if present, can be in a range from 0.2 mm to 1 mm. The thickness T5 of the sheath structure 400, which is the sum of the thicknesses T6 and T7, can be in a range from 3.2 mm to 11 mm.

When the sheath structure 400 and sheath structure 300 are used in constructing different parts of the sheath 102, the thickness T5 of the sheath structure 400 may be the same as or greater than the thickness T of the sheath structure 300 (see thickness T in FIGS. 13A-13D). In some examples, the thickness T7 of the outer sheath layer 406 of the sheath structure 400 may be the same as the thickness T3 (see FIGS. 13A-13D) of the outer sheath layer 306 of the sheath structure 300 regardless of whether the thicknesses T and T5 are the same or different (i.e., when both sheath structures 300, 400 are used in the sheath 102, the thickness of the outer sheath layer 102b of the sheath 102 can be uniform throughout, while the thickness of the inner sheath layer 102a of the sheath may be uniform or non-uniform).

### Example VII—Method

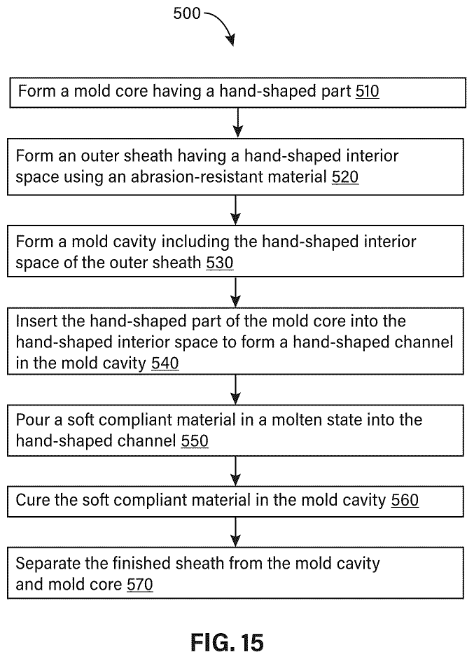

FIG. 15 illustrates an example method 500 of making a compliant covering for a hand (e.g., a robotic hand). The operations in the method 500 are illustrated in a particular order, but the operations may be reordered as appropriate.

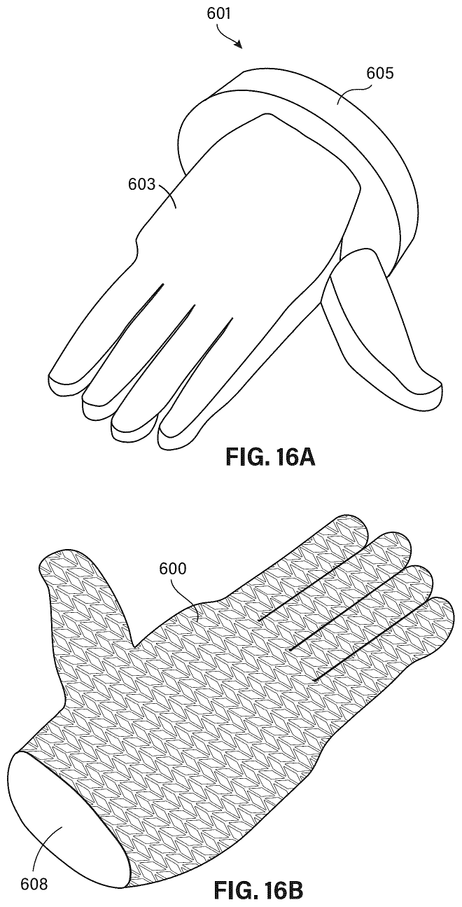

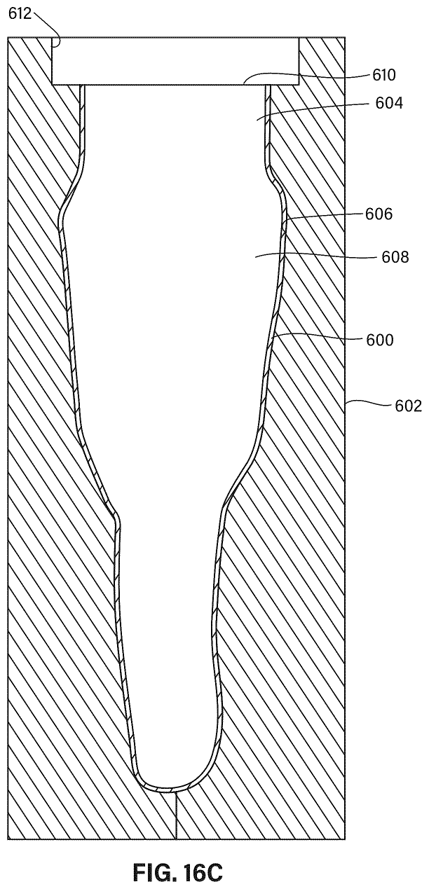

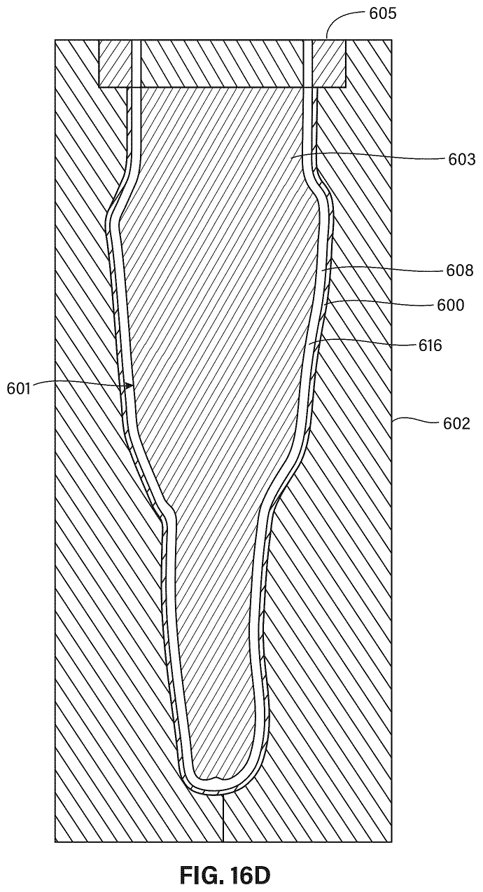

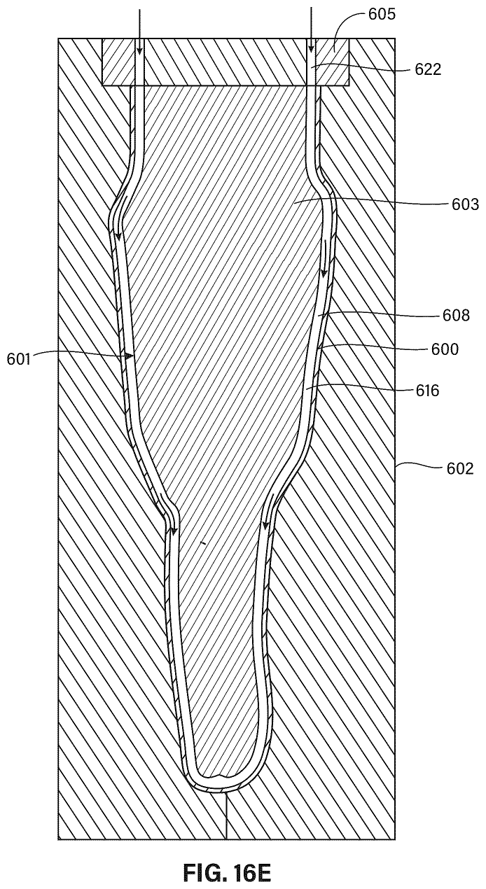

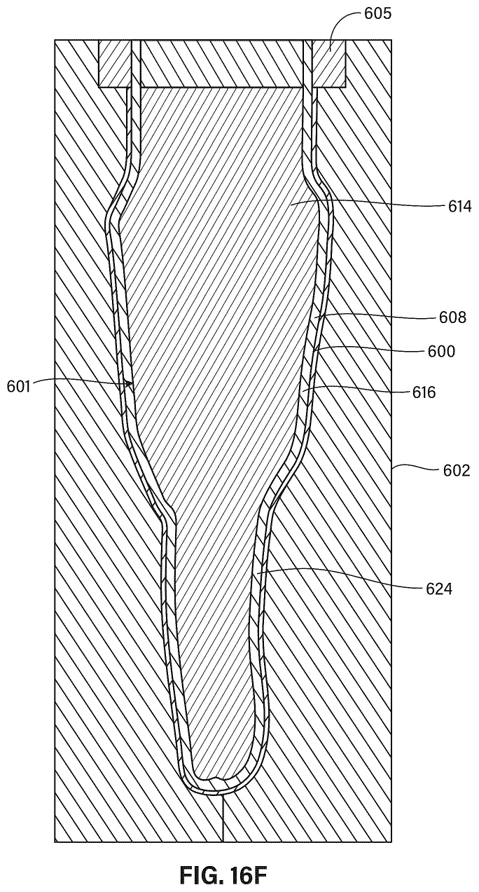

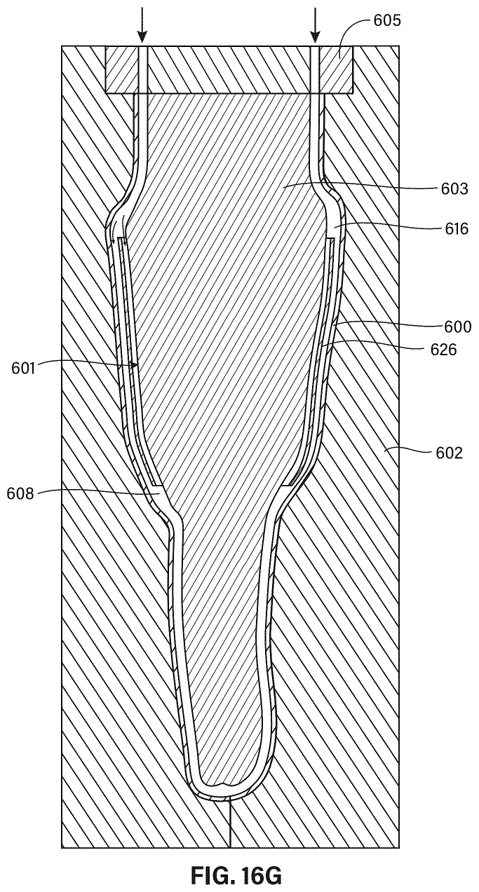

At 510, the method can include forming a mold core including a hand-shaped part. The hand-shaped part of the mold core can be based on a given 3D model of a hand (e.g., a robotic hand). The hand-shaped part represents the outer shape, size, and form of the hand model, including the outer shape, size, form, and location of any sensors on the hand model. The mold core may be made of a material suitable for an injection mold (e.g., a material that can withstand the temperatures the mold core would be exposed to while forming the compliant covering). The mold core may be made by 3D printing or other suitable method (e.g., machining). FIG. 16A shows an example mold core 601 including a hand-shaped part 603. The mold core 601 may include a support part 605 attached to a proximal end of the hand-shaped part 603. The support part 605 may be used to support the mold core 601 in a mold cavity.

At 520 in FIG. 15, the method can include forming an outer sheath having a hand-shaped interior space using an abrasion-resistant material. The interior space of the outer sheath has a shape that is based on the shape of the hand-shaped part of the mold core. The interior space may be oversized relative to the hand-shaped part of the mold core by a layer thickness of an inner sheath to be formed inside the outer sheath. In some examples, the outer sheath is composed of a fabric. The outer sheath can be formed, for example, using a 3D knitting machine. The outer sheath may be made as a seamless piece that defines the interior space or as multiple pieces that can be assembled together to define the interior space. FIG. 16B shows an example outer sheath 600 having a hand-shaped interior space 608.

At 530 in FIG. 15, the method can include forming a mold cavity including the hand-shaped interior space of the outer sheath. In some examples, the outer sheath formed in operation 520 can be supported in a backing mold to form the mold cavity including the interior space of the outer sheath. FIG. 16C shows an example of a backing mold 602 having a mold cavity 604 in the shape of the outer sheath 600. The outer sheath 600 is supported in the backing mold 602 by mounting the outer sheath 600 onto a wall 606 of the mold cavity 604, whereby the interior space 608 of the outer sheath 600 becomes part of the mold cavity 604. The outer sheath 600 can be mounted to the cavity wall 606 using any suitable method. For example, the outer sheath 600 may be temporarily bonded to the cavity wall 606 using an adhesive material that can be dissolved when the outer sheath 600 is removed from the backing mold 602. The backing mold 602 may include an opening 612 that is aligned with an opening 610 at an end of the outer sheath 600. The opening 610 is connected to the interior space 608 of the outer sheath 600. The openings 610, 612 form a passage through which the hand-shaped part of the mold core formed in operation 510 can be inserted into the interior space 608 of the outer sheath 600.

At 540 in FIG. 15, the method can include inserting the hand-shaped part of the mold core formed in operation 510 into the mold cavity formed in operation 530. The hand-shaped part is inserted into the interior space of the outer sheath within the mold cavity. Since the interior space is oversized relative to the hand-shaped part, a hand-shaped channel is defined between the hand-shaped part and the outer sheath to receive molten material. FIG. 16D shows an example of the hand-shaped part 603 of the mold core 601 inserted into the interior space 608 of the outer sheath 600 and a hand-shaped channel 616 formed between the hand-shaped part 603 and the outer sheath 600. The hand-shaped part 603 may be suspended within the interior space 608 by mounting the support part 605 at the opening 612 of the backing mold 602. In some examples, the support part 605 may be used to center the hand-shaped part 603 within the interior space 608 such that the hand-shaped channel 616 has the proper thickness profile around the hand-shaped part 603.

At 550 in FIG. 15, the method can include pouring molten soft compliant material into the hand-shaped channel formed in the mold cavity. The arrows in FIG. 16E indicate movement of molten soft compliant material into the hand-shaped channel 616. In some examples, the support part 605 of the mold core 601 may include openings 622 that are aligned with the hand-shaped channel 616. The molten material may be poured into the hand-shaped channel 616 through the openings 622 of the support part 605. The molten material poured into the hand-shaped channel 616 may invade open spaces (or pores) in the outer sheath 600 (e.g., to allow an interlocking interface to be formed between the outer sheath and the material in the hand-shaped channel 616). The molten material may be poured into the hand-shaped channel 616 until there is overflow at the openings 622 of the support part 605, signaling that the hand-shaped channel 616 is full (including with a desired level of molten material invasion into the open spaces of the outer sheath 600). In some examples, the mold assembly may be rotated while pouring the molten material into the hand-shaped channel 616 so that the hand-shaped channel 616 is evenly filled with the molten material. FIG. 16F shows the hand-shaped channel 616 filled with the molten soft compliant material 624, which would correspond to an inner sheath when cured.

At 560 in FIG. 15, the soft compliant material in the mold cavity is cured to form an inner sheath that is secured to (e.g., interlocked and bonded with) the outer sheath.

At 570, the sheath composed of the inner sheath and outer sheath is separated from the backing mold and mold core. Any excess material at the end of the inner sheath can be trimmed off.

The outer sheath may have slits (see, e.g., slits 114a-d, 116 in FIG. 7A). After separating the sheath from the backing mold and mold core in operation 570, the inner sheath may be cut open at locations corresponding to the slits in the outer sheath so that the slits extend through the thickness of the sheath.

Operations 510 to 570 can be used to form a sheath having the sheath structure 300 in Example III and FIGS. 13A-13E. To form the sheath structure 400 in Example IV in a part of the sheath, operation 540 may optionally include inserting a reinforcement member (see, e.g., reinforcement member 420 in FIGS. 14A-14D) into a section of the hand-shaped channel corresponding to where reinforcement of the sheath is desired. This would result in a reinforcement member that is embedded in the inner sheath when molten material is poured into the hand-shaped channel and subsequently cured. FIG. 16G shows an example of inserting a reinforcement member 626 in a section of the hand-shaped channel 616. The reinforcement member 626 may be temporarily coupled to the hand-shaped part 605 of the mold core 601, for example, for support within the hand-shaped channel gap 616.

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.

Example 1: A compliant covering for a hand comprises a sheath having an interior space to receive at least a part of the hand. The sheath comprises an inner sheath layer having an inner surface defining a boundary of the interior space and an outer sheath layer at least partially covering an exterior of the inner sheath layer. The outer sheath layer has an outer surface forming an exterior of the sheath. The inner sheath layer is formed of a first material. The outer sheath layer is formed of a second material having a higher abrasion resistance compared to the first material.

Example 2: A compliant covering according to Example 1, wherein the first material is a soft compliant material, and wherein the second material is an abrasion-resistant material.

Example 3: A compliant covering according to Example 2, wherein the soft compliant material is a soft elastomer.

Example 4: A compliant covering according to Example 3, wherein the soft elastomer is silicone elastomer.

Example 5: A compliant covering according to Example 3, wherein the abrasion-resistant material is a fabric.

Example 6: A compliant covering according to Example 5, wherein the fabric is a 3D knitted fabric.

Example 7: A compliant covering according to Example 3, wherein the abrasion-resistant material is an abrasion-resistant elastomer.

Example 8: A compliant covering according to Example 3, wherein the abrasion-resistant material is a high abrasion rubber.

Example 9: A compliant covering according to Example 1, wherein a thickness of the inner sheath layer is in a range from 3 mm to 10 mm, and wherein a thickness of the outer sheath layer is in a range from 0.2 mm to 1 mm.

Example 10: A compliant covering according to Example 2, wherein an interlocking interface is formed between the inner sheath layer and the outer sheath layer comprising portions of the soft compliant material interlocked with portions of the abrasion-resistant material.

Example 11: A compliant covering according to Example 10, wherein a thickness of the interlocking interface is in a range from 0.2 mm to 1 mm, and a combined thickness of the inner sheath layer and the outer sheath layer is in a range from 3 mm to 7 mm.

Example 12: A compliant covering according to Example 2, further comprising a reinforcement member embedded in the soft compliant material forming at least a portion of the inner sheath layer, the reinforcement member formed of a reinforcement material having a higher strength compared to the soft compliant material.

Example 13: A compliant covering according to Example 12, wherein the soft compliant material is a soft elastomer, and wherein the reinforcement material is a plastic or a metal.

Example 14: A compliant covering according to Example 12, wherein the reinforcement member comprises pores, and wherein the soft compliant material extends through the pores to form an interlocking engagement between the soft compliant material and the reinforcement material in the at least a portion of the inner sheath layer.

Example 15: A compliant covering according to Example 12, wherein the at least a portion of the inner sheath layer is shaped to cover a palm of the hand.

Example 16: A compliant covering according to Example 12, wherein a thickness of the inner sheath layer is in a range from 3 mm to 10 mm, a thickness of the outer sheath layer is in a range from 0.2 mm to 1 mm, and a thickness of the reinforcement member is in a range from 0.1 to 0.3 mm.

Example 17: A compliant covering according to Example 12, wherein an interlocking interface is formed between the inner sheath layer and the outer sheath layer comprising portions of the soft compliant material interlocked with portions of the abrasion-resistant material.

Example 18: A compliant covering according to Example 17, wherein a thickness of the interlocking interface is in a range from 0.2 mm to 1 mm, and wherein a combined thickness of the inner sheath layer and the outer sheath layer is in a range from 3.2 mm to 11 mm.

Example 19: A compliant covering according to Example 1, wherein the inner surface includes at least one depression to receive a protruding sensor part on the hand.

Example 20: A compliant covering according to Example 19, wherein a surface of the at least one depression includes an interlocking profile to interlockingly engage the protruding sensor part on the hand.

Example 21: A compliant covering according to Example 1, wherein at least a portion of the inner surface includes an interlocking profile to interlockingly engage a surface of the hand.

Example 22: A compliant covering according to Example 1, wherein the sheath comprises finger sheath parts having finger portions of the interior space to receive fingers of the hand, a thumb sheath part having a thumb portion of the interior space to receive a thumb of the hand, and a palm sheath part having a palm portion of the interior space to receive a palm of the hand.

Example 23: A compliant covering according to Example 22, further comprising a slit formed in at least one of the sheath parts, the slit extending through thicknesses of the inner sheath layer and the outer sheath layer in the at least one of the sheath parts.

Example 24: A compliant covering according to Example 23, further comprising holes formed in opposite edge portions of the slit.

Example 25: A compliant covering according to Example 23, further comprising a closure element coupled to opposite edge portions of the slit.

Example 26: A compliant covering according to Example 23, further comprising a strap coupled to the sheath and extendible across opposite edge portions of the slit.

Example 27: A method of making a compliant covering for a hand comprising: obtaining a mold core including a hand-shaped part; forming an outer sheath from a fabric, wherein the outer sheath has an interior space shaped to receive the hand-shaped part with an allowance; mounting the outer sheath in a backing mold to form a mold cavity including the interior space; inserting the hand-shaped part of the mold core into the interior space in the mold cavity to form a hand-shaped channel between the hand-shaped part and the outer sheath; pouring a soft elastomer in a molten state into the mold cavity, wherein the soft elastomer flows into the hand-shaped channel and permeates the outer sheath; curing the soft elastomer in the mold cavity, wherein the cured soft elastomer in the hand-shaped channel forms an inner sheath, and wherein the inner sheath is interlocked with the outer sheath to form a sheath with a sheath structure; and separating the sheath from the mold cavity and mold core.

Example 28: A method according to Example 27, further comprising disposing a reinforcement member made of a material having a higher strength compared to the cured soft elastomer in a section of the hand-shaped channel prior to pouring the molten soft elastomer into the mold cavity.

1. A compliant covering for a hand, the compliant covering comprising:
a sheath having an interior space to receive at least a part of the hand, the sheath comprising:
an inner sheath layer having an inner surface defining a boundary of the interior space, the inner sheath layer formed of a first material; and
an outer sheath layer at least partially covering an exterior of the inner sheath layer, the outer sheath layer having an outer surface forming an exterior of the sheath, the outer sheath layer formed of a second material having a higher abrasion resistance compared to the first material.

2. The compliant covering of claim 1, wherein the first material is a soft compliant material, and wherein the second material is an abrasion-resistant material.

3. The compliant covering of claim 2, wherein the first material is a soft elastomer.

4. The compliant covering of claim 3, wherein the second material is a fabric.

5. The compliant covering of claim 4, wherein the fabric is a 3D knitted fabric.

6. The compliant covering of claim 3, wherein the second material is an abrasion-resistant elastomer.

7. The compliant covering of claim 2, wherein a thickness of the inner sheath layer is in a range from 3 mm to 10mm, and wherein a thickness of the outer sheath layer is in a range from 0.2 mm to 1 mm.

8. The compliant covering of claim 2, wherein an interlocking interface is formed between the inner sheath layer and the outer sheath layer comprising portions of the first material interlocked with portions of the second material.

9. The compliant covering of claim 8, wherein a thickness of the interlocking interface is in a range from 0.2 mm to 1 mm, and a combined thickness of the inner sheath layer and the outer sheath layer is in a range from 3 mm to 7 mm.

10. The compliant covering of claim 2, further comprising a reinforcement member embedded in the first material forming at least a portion of the inner sheath layer, the reinforcement member formed of a third material having a higher strength compared to the first material.

11. The compliant covering of claim 10, wherein the first material is a soft elastomer, and wherein the third material is a plastic or a metal.

12. The compliant covering of claim 10, wherein the reinforcement member comprises pores, and wherein the first material extends through the pores to form an interlocking engagement between the first material and the third material in the at least a portion of the inner sheath layer.

13. The compliant covering of claim 10, wherein a thickness of the inner sheath layer is in a range from 3 mm to 10 mm, a thickness of the outer sheath layer is in a range from 0.2 mm to 1 mm, and a thickness of the third material is in a range from 0.1 to 0.3 mm.

14. The compliant covering of claim 10, wherein an interlocking interface is formed between the inner sheath layer and the outer sheath layer comprising portions of the first material interlocked with portions of the second material.

15. The compliant covering of claim 14, wherein a thickness of the interlocking interface is in a range from 0.2 mm to 1 mm, and wherein a combined thickness of the inner sheath layer and the outer sheath layer is in a range from 3.2 mm to 11 mm.

16. The compliant covering of claim 1, wherein the inner surface includes at least one depression to receive a protruding sensor part on the hand.

17. The compliant covering of claim 16, wherein a surface of the at least one depression includes an interlocking profile to interlockingly engage the protruding sensor part on the hand.

18. The compliant covering of claim 1, wherein at least a portion of the inner surface includes an interlocking profile to interlockingly engage a surface of the hand.

19. A method of making a compliant covering for a hand, the method comprising:
obtaining a mold core including a hand-shaped part;
forming an outer sheath from a fabric, wherein the outer sheath has an interior space shaped to receive the hand-shaped part with an allowance;
mounting the outer sheath in a backing mold to form a mold cavity including the interior space;
inserting the hand-shaped part of the mold core into the interior space in the mold cavity to form a hand-shaped channel between the hand-shaped part and the outer sheath;
pouring a soft elastomer in a molten state into the mold cavity, wherein the soft elastomer flows into the hand-shaped channel and permeates the outer sheath;
curing the soft elastomer in the mold cavity, wherein the cured soft elastomer in the hand-shaped channel forms an inner sheath, and wherein the inner sheath is interlocked with the outer sheath to form a sheath with a sheath structure; and
separating the sheath from the mold cavity and mold core.

20. The method of claim 19, further comprising disposing a reinforcement member made of a material having a higher strength compared to the cured soft elastomer in a section of the hand-shaped channel prior to pouring the molten soft elastomer into the mold cavity.
